(19) United States
(12) Patent Application Publication
(10) Pub. No.: US 2026/0339816 A1
(43) Pub. Date: Oct. 29, 2026

(54) LOG ANALYSIS SUPPORT METHOD, LOG ANALYSIS SUPPORT SYSTEM, AND LOG ANALYSIS SUPPORT PROGRAM

(71) Applicant: Hitachi, Ltd., Tokyo (JP)

(72) Inventors: Ryoya TSURUOKA, Tokyo (JP); Mineyoshi MASUDA, Tokyo (JP)

(21) Appl. No.: 19/540,377

(22) Filed: Feb. 13, 2026

(30) Foreign Application Priority Data
Apr. 23, 2025 (JP) 2025-071457

(51) Int. Cl. G06F 11/34; G06F 11/07; G06F 11/30

(52) U.S. Cl. CPC G06F 11/3476; G06F 11/0766; G06F 11/0787; G06F 11/079; G06F 11/3072

(57) ABSTRACT

A log analysis support method executed by a log analysis support system for supporting analysis of logs which are output when an incident occurs at a target system. The log analysis support system has a processor and a memory. The memory stores system configuration information having storage location information indicating storage locations of log files in which the logs relating to constituent elements that configures the target system are stored, and rule information indicating the constituent element, which are targets to acquire the logs, with respect to failure information indicating details of the incident or failure occurrence location information indicating the constituent element where the incident has occurred. The processor has respective processes for accepting the failure information, the failure occurrence location information, and an analysis target period which are input by a user, and identifying the storage location information of the log files.

This application claims priority based on Japanese patent application, No. 2025-71457 filed on Apr. 23, 2025, the entire contents of which are incorporated herein by reference.

### TECHNICAL FIELD

The present invention relates to a log analysis support method, a log analysis support system, and a log analysis support program.

### BACKGROUND ART

A system such as a computer composed of hardware and software records events which occur at the system, such as various kinds of operations and accesses from outside, as logs. Regarding the logs of the above-described system, log analysis is performed and is used to identify the cause of a failure upon the occurrence of the failure, detect signs of a system abnormality, and detect unauthorized access to the system.

In general, the log analysis is performed by a user such as an administrator who is familiar with the system based on their knowledge and experiences. Therefore, the accuracy of the log analysis depends on the skills of the user, which becomes a heavy burden on the user.

In addition, in recent years, many systems have come to output logs, and the amount of logs has increased dramatically. Therefore, it has become difficult for the user to analyze a large amount of logs without omission.

For example, PTL1 discloses the following conventional technology for a log analysis method when a failure occurs. Specifically speaking, each of log entries in the logs is vectorized, clustering is performed between logs with a close vector distance, and a log entry with the smallest number of elements in the formed cluster is presented. Consequently, the number of the log entries to be analyzed when a system failure occurs is reduced significantly and the burden is thereby reduced.

### CITATION LIST

### PATENT LITERATURE

PTL 1: Japanese Patent Application Laid-Open (Kokai) Publication No. 2018-132787

### SUMMARY OF THE INVENTION

### PROBLEMS TO BE SOLVED BY THE INVENTION

However, with the above-described conventional technology, for example, if a large number of the same log entries are output by a plurality of systems upon the occurrence of a failure, the number of elements in clusters of the same log entries becomes large, so the same log entries will be excluded from the log entries to be presented. Accordingly, the above-described conventional technology sometimes fails to acquire the log entries which are important to identify the cause of the failure.

In such a case, the number of log entries which are targets to be checked ranges from hundreds to thousands of lines with respect to logs of the plurality of systems. The user is required to have the knowledge and experiences of the systems when performing the log analysis, and a huge amount of effort is also required to analyze a large amount of logs across the plurality of systems.

The present invention was devised in consideration of the above-described circumstances, and it is one of its objects to enable the user to analyze the large amount of logs across the plurality of systems without any burden and without requiring the knowledge or experiences of the systems.

### MEANS TO SOLVE THE PROBLEMS

In order to achieve the above-described object, there is provided according to an aspect of the present invention a log analysis support method executed by a log analysis support system for supporting analysis of logs which are output when an incident occurs at a target system, wherein the log analysis support system has a processor and a memory; wherein the memory stores: system configuration information having storage location information indicating storage locations of log files in which the logs relating to constituent elements that configure the target system are stored; and rule information indicating the constituent elements, which are targets to acquire the logs, with respect to failure information indicating details of the incident or failure occurrence location information indicating the constituent element where the incident has occurred; and wherein the processor has respective processes for: accepting the failure information, the failure occurrence location information, and an analysis target period which are input by a user; identifying the storage location information of the log files, which are analysis targets, based on the failure information or the failure occurrence location information as well as the system configuration information and the rule information; acquiring the analysis target log files which correspond to the analysis target period, from the target system by using the identified storage location information; deciding, according to a quantity of the analysis target log files, a processing method for generating cluster information based on a cluster or clusters generated by clustering the logs based on content of the logs stored in the acquired analysis target log files; generating the cluster information by using the decided processing method; and outputting support information for supporting the analysis of the logs based on the generated cluster information.

### ADVANTAGEOUS EFFECTS OF THE INVENTION

If the present invention is employed, for example, the user can analyze a large amount of logs across a plurality of systems without burden and even without the knowledge or experiences of the systems.

### BRIEF DESCRIPTION OF DRAWINGS

FIG. 1 is a diagram for explaining the outline of Embodiment 1;

FIG. 2 is a diagram illustrating the configuration of the entire system including a log analysis support system according to Embodiment 1;

FIG. 3 is a diagram illustrating log information according to Embodiment 1;

FIG. 4 is a diagram illustrating the configuration of rule information according to Embodiment 1;

FIG. 5 is a diagram illustrating the configuration of system configuration information according to Embodiment 1;

FIG. 6 is a diagram illustrating the configuration of cluster information according to Embodiment 1;

FIG. 7 is a flowchart illustrating log analysis processing according to Embodiment 1;

FIG. 8 is a flowchart illustrating single log analysis processing according to Embodiment 1;

FIG. 9 is a flowchart illustrating cross-sectional log analysis processing according to Embodiment 1;

FIG. 10 is a diagram illustrating the configuration of a log analysis support input screen according to Embodiment 1;

FIG. 11 is a diagram illustrating the configuration of a log analysis support output screen according to Embodiment 1;

FIG. 12 is a diagram illustrating the configuration of a log analysis support input screen according to Embodiment 2;

FIG. 13 is a flowchart illustrating re-analysis processing according to Embodiment 2;

FIG. 14 is a diagram illustrating the configuration of a log analysis support input screen according to Embodiment 3;

FIG. 15 is a flowchart illustrating single log analysis processing according to Embodiment 3; and

FIG. 16 is a flowchart illustrating cross-sectional log analysis processing according to Embodiment 3.

### DESCRIPTION OF EMBODIMENTS

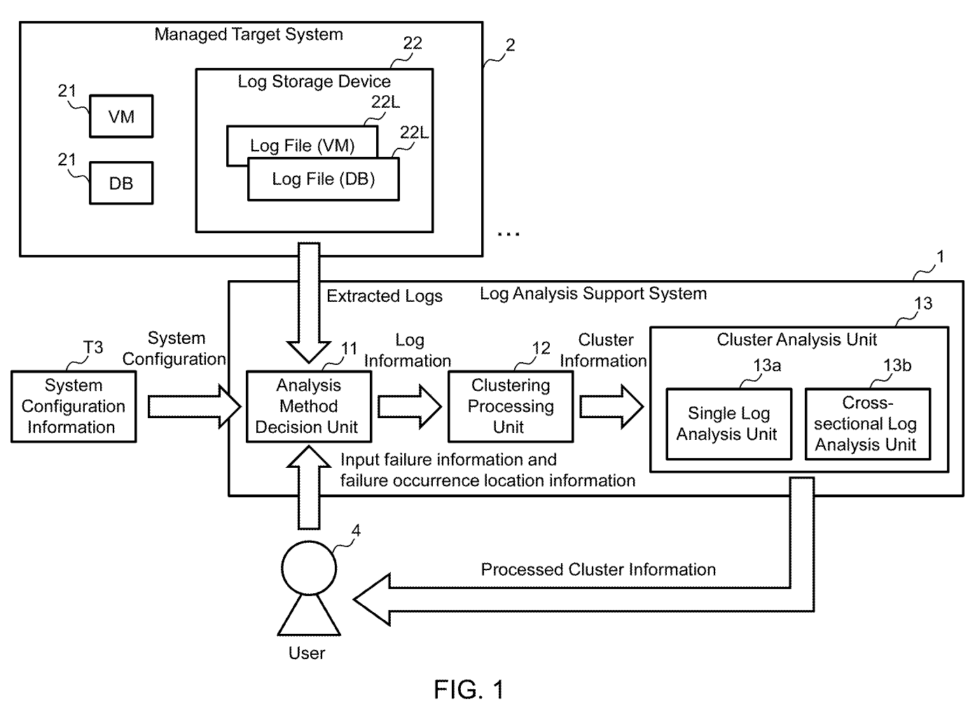

Embodiments according to the present invention will be described below in detail with reference to FIGS. 1 to 16. Incidentally, the present invention is not limited by the embodiments described below.

### Embodiment 1

### Outline of Embodiment 1

FIG. 1 is a diagram for explaining the outline of an embodiment. As triggered when an incident occurs in an execution environment of a managed target system 2 for executing services and failure information of the system is input by a user 4, a log analysis support system 1 executes analysis of logs relating to the incident and presents the analysis results.

Services 21 such as VM and DB operate at the managed target system 2. The managed target system 2 has a log storage device 22. The log storage device 22 stores system configuration information of the managed target system 2 and log files 22L in which logs of the respective services 21 are stored.

The log analysis support system 1 has an analysis method decision unit 11, a clustering processing unit 12, and a cluster analysis unit 13. The analysis method decision unit 11 receives the failure information and failure occurrence location information from the user 4. The failure information is information indicating the details such as a message about the incident or failure which has occurred at the managed target system 2. The failure occurrence location information indicates the service 21 or a constituent element such as hardware at which where the incident or failure has occurred at the managed target system 2.

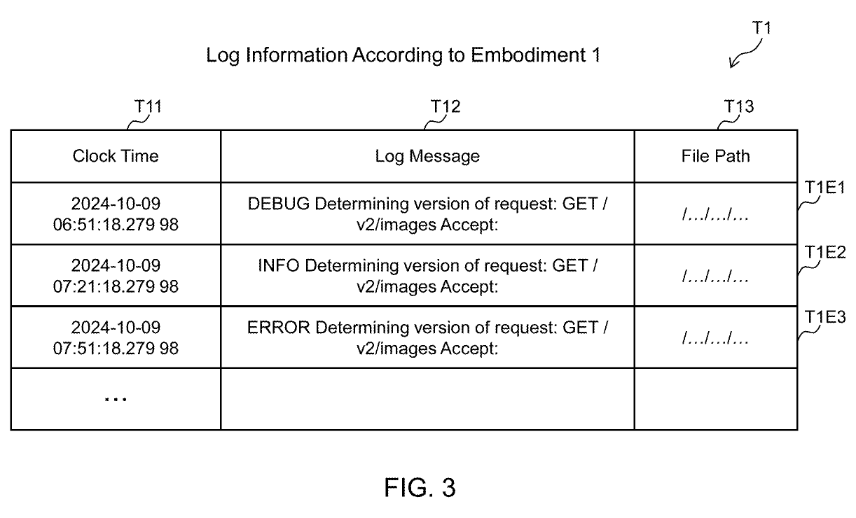

Moreover, the analysis method decision unit 11 receives system configuration information from a system configuration information table 3. Furthermore, the analysis method decision unit 11 receives system configuration information T3 of the managed target system 2 from the log storage device 22, and each log entry extracted from a log file 22L corresponding to the failure information and the failure occurrence location information. The analysis method decision unit 11 stores log entries, which are received from the log storage device 22, in log information T1 (FIG. 3). The analysis method decision unit 11 decides a method for analyzing logs, depending on whether the number of log files 22L is one or more than one.

The clustering processing unit 12 executes clustering of the log information T1 and outputs the clustering results to the cluster analysis unit 13.

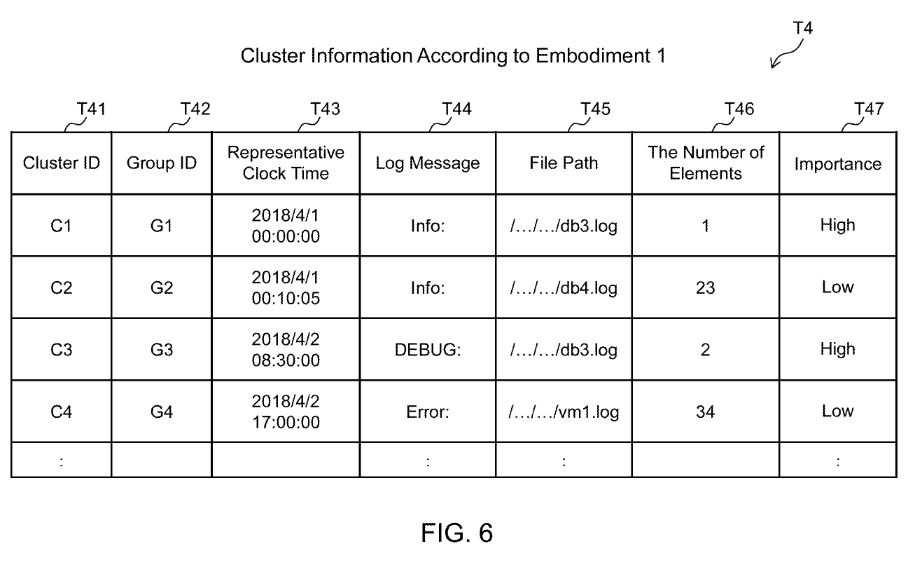

The cluster analysis unit 13 receives the clustering results from the clustering processing unit 12. The cluster analysis unit 13 generates cluster information T4 (FIG. 6) from the received clustering results by using a single log analysis unit 13a or a cross-sectional log analysis unit 13b according to the decision result of the log analysis method by the analysis method decision unit 11. The cluster analysis unit 13 generates support information for supporting the analysis of logs based on the cluster information T4 and presents it to the user 4.

### Configuration of the Entire System S According to Embodiment 1

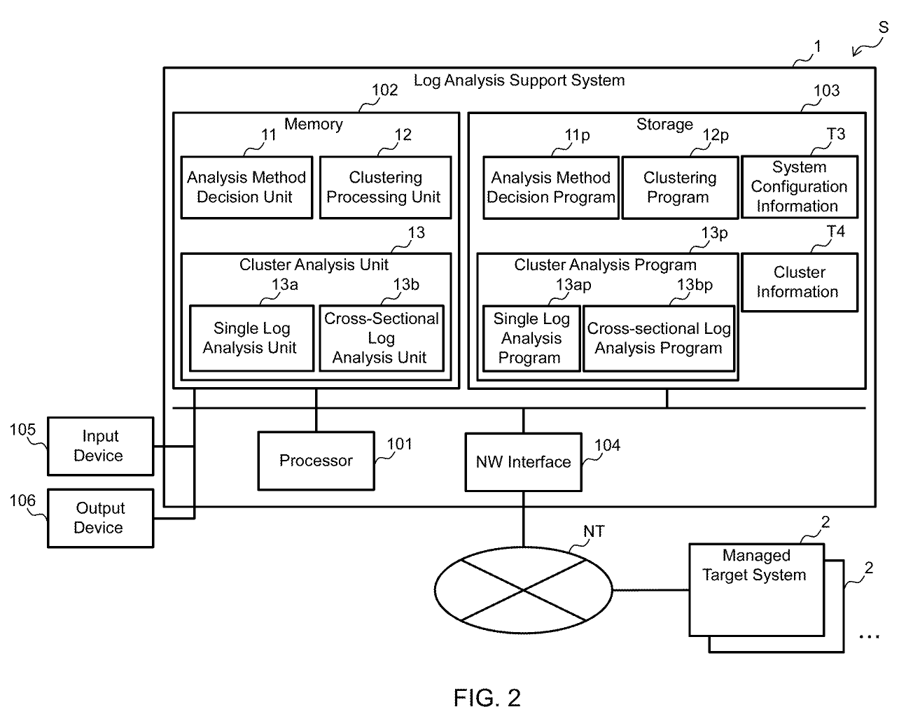

FIG. 2 is a diagram illustrating the configuration of the entire system S including the log analysis support system 1 according to Embodiment 1. The log analysis support system 1 operates on a computer for managing the managed target system 2 and is connected with the managed target system 2 via a network NT.

The log analysis support system 1 has a processor 101, a memory 102, a storage 103, an NW interface 104, an input device 105, and an output device 106. The processor 101 is an arithmetic processing device for executing arithmetic processing such as a CPU and a GPU. The memory 102 cooperates with the processor 101 and stores data to be used by the processor 101 when executing programs.

The storage 103 is a nonvolatile data storage device. The storage 103 stores an analysis method decision program 11p, a clustering program 12p, a cluster analysis program 13p, the system configuration information T3, and the cluster information T4. The cluster analysis program 13p includes a single log analysis program 13ap and a cross-sectional log analysis program 13bp.

The analysis method decision program 11p, the clustering program 12p, and the cluster analysis program 13p (the single log analysis program 13ap and the cross-sectional log analysis program 13bp) are loaded to the memory 102 and are executed by the processor 101. Consequently, the processor 101 implements the analysis method decision unit 11, the clustering processing unit 12, and the cluster analysis unit 13 (the single log analysis unit 13a and the cross-sectional log analysis unit 13b), respectively.

The details of processing of the analysis method decision unit 11, the clustering processing unit 12, and the cluster analysis unit 13 (the single log analysis unit 13a and the cross-sectional log analysis unit 13b) will be described later.

Incidentally, the clustering processing unit 12 and the clustering program 12p may be mounted in a computer(s) other than the log analysis support system 1.

The NW interface 104 is a communication device for the log analysis support system 1 to communicate with external computers via the network NT. The input device 105 accepts input of, for example, the details of the failure by the user 4. The output device 106 displays the support information for supporting the analysis of logs such as the analysis results by the cluster analysis unit 13.

The managed target system 2 is a log analysis target system. The managed target system 2 is composed of one or a plurality of computers and software which operates on the computer(s) (and which is not illustrated in the drawing). The computer on which the managed target system 2 operates has a similar configuration to that of the computer on which the log analysis support system 1 operates. An OS, middleware, and various kinds of business programs operate on the computer where the managed target system 2 operates, and they output log entries to the corresponding log file 22L in the log storage device (FIG. 1).

### Log Information T1 According to Embodiment 1

FIG. 3 is a diagram illustrating the log information T1 according to Embodiment 1. The log information T1 is a table that stores entries of a log file 22L extracted from the log file 22L which is the analysis target. For example, each line of lines T1E1, T1E2, T1E3, and so on stores information relating to log entries based on the same incident of the same managed target system 2.

The log information T1 stores respective columns of a clock time T11, a log message T12, and a file path T13. The clock time T11 indicates a clock time when the relevant entry was output. The log message T12 indicates the details of a message of the relevant log entry. The file path T13 indicates a storage path for the log file 22L in which the relevant log entry is stored. The file path T13 corresponds to any one of file paths T32 stored in the system configuration information T3 described later.

### Rule Information T2 according to Embodiment 1

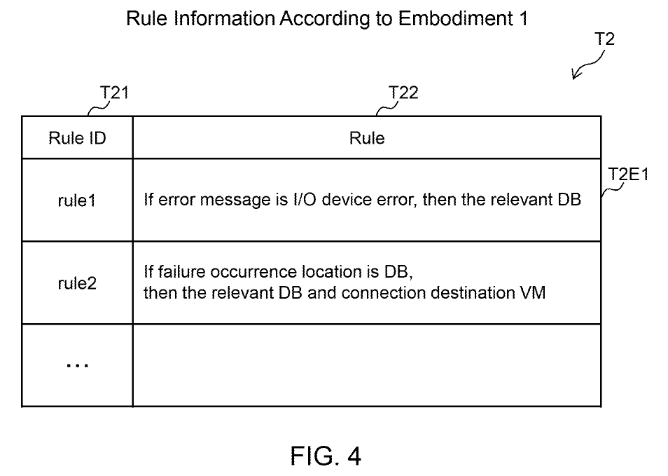

FIG. 4 is a diagram illustrating the configuration of rule information T2 according to Embodiment 1. The rule information T2 is a table in which rules for deciding a log file 22L to be acquired when the failure information is input by the user 4. The rule information T2 has respective columns of a rule ID_T21 and a rule T22.

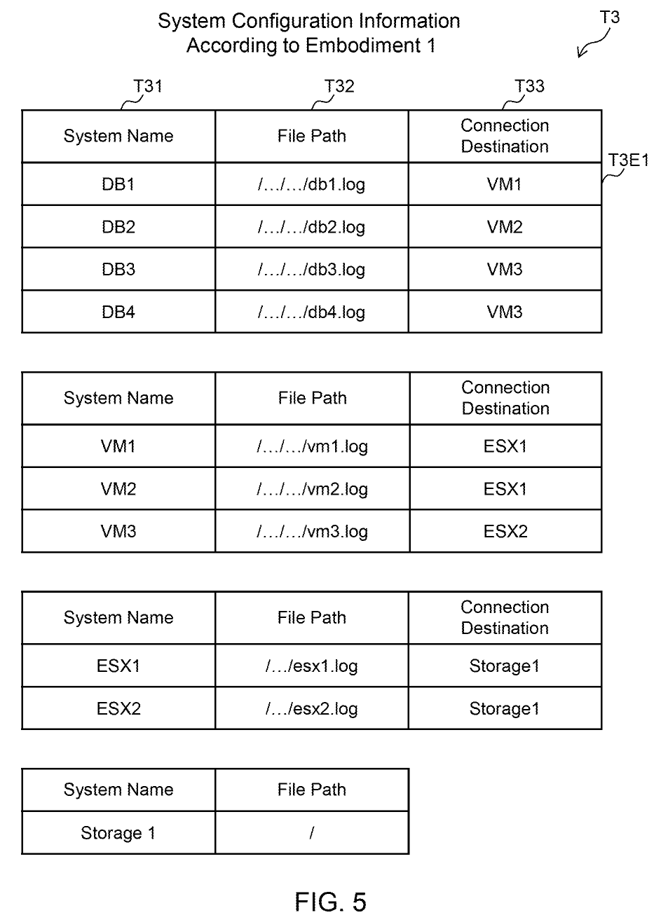

The rule ID_T21 stores identification information of a rule stored in the rule T22. For example, the analysis method decision unit 11 refers to the rule information T2 and decides the log file 22L to be acquired based on the details of the failure, which are input by the user 4, the system configuration information T3, and the rule T22. For example, when the user 4 inputs that a failure has occurred at “DB3” as the failure information, a log file 22L for “DB3” and a log file 22L for “VM3” which is a connection destination T33 of “DB3” (see FIG. 5) are acquired based on the rule ID_T21 “rule2”.

### System Configuration Information T3 according to Embodiment 1

FIG. 5 is a diagram illustrating the configuration of the system configuration information T3 according to Embodiment 1. The system configuration information T3 stores information about the configuration of the managed target system 2. The system configuration information T3 has respective columns of a system name T31, a file path T32, and the connection destination T33.

The system name T31 indicates the name of the relevant system in the managed target system 2. The system name T31 may be, for example, a unique ID which is valid as identification information. The file path T32 indicates storage location information of the log file 22L to be output by the relevant system in the managed target system 2. The connection destination T33 indicates another system to which the relevant system identified by the system name T31 is connected. For example, you can see, by referring to a row T3E1, that the system name T31 “DB1” has its log file 22L stored in the file path T32 “/…/…/db1.log” and is connected to the connection destination T33 “VM1.”

### Cluster Information T4 According to Embodiment 1

FIG. 6 is a diagram illustrating the configuration of the cluster information T4 according to Embodiment 1. The cluster information T4 is information generated based on a cluster generated by clustering log entries of log files 22L which are output by the managed target system 2. The cluster information T4 has respective columns of a cluster ID_T41, a group ID_T42, a representative clock time T43, a log message T44, a file path T45, the number of elements T46, and importance T47.

The cluster ID_T41 is identification information of the relevant cluster. The group ID_T42 is identification information of a group to which the relevant cluster belongs by grouping. When the group ID is not assigned, the group ID_T42 becomes NULL. The representative clock time T43 is clock time information assigned to the relevant cluster. The log message T44 corresponds to message information (the log message T12 in the log information T1) of one log entry among log entries included in the relevant cluster.

The file path T45 indicates the storage location of a log entry included in the relevant cluster. The file path T45 corresponds to any one of the file paths T32 of the system configuration information T3. The number of elements T46 indicates the number of log entries included in the relevant cluster.

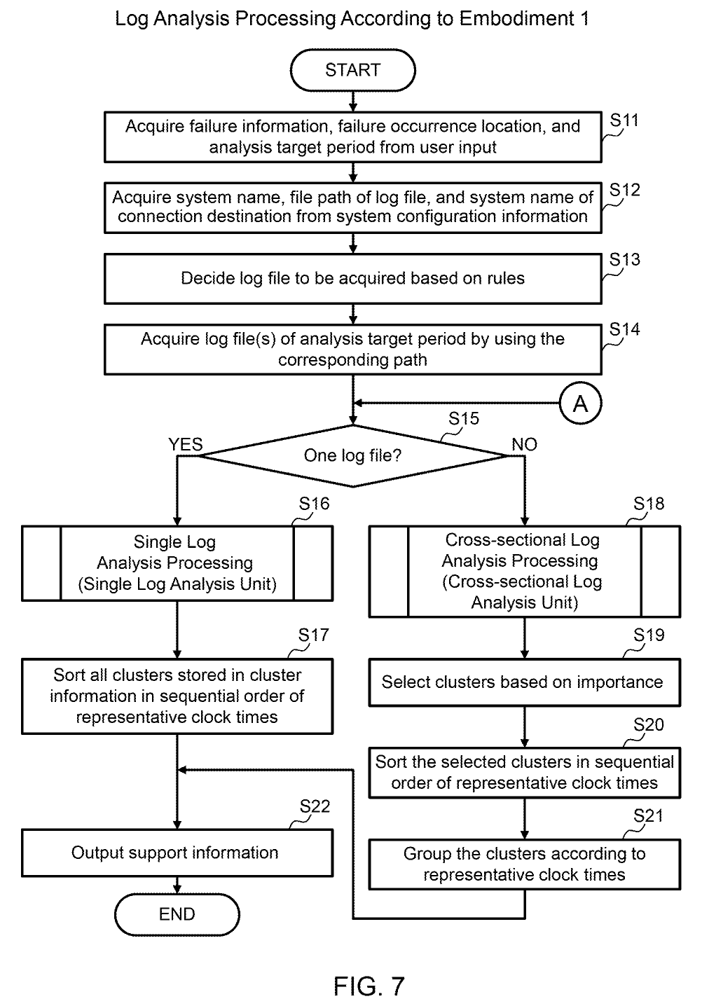

The importance T47 indicates the importance of the relevant cluster. The importance T47 stores, for example, information for classifying clusters into graded levels ranging from high importance to low importance such as High/Low or 3/2/1. The information of the importance T47 is assigned to clusters generated by cross-sectional log analysis processing (step S18) (FIG. 7) of log analysis processing described later and is not assigned to clusters generated by single log analysis processing (step S17) (FIG. 7) of the log analysis processing described later. The information of the importance T47 may be decided so that when the number of the log files 22L, which are analysis targets, is larger, the importance is classified into a larger number of graded levels. For example, if the number of the analysis target log files 22L is equal to or more than a certain number, the information of the importance T47 is divided into five graded levels like 5/4/3/2/1; and if the number of the analysis target log files 22L is less than the certain number, the information of the importance T47 is divided into three graded levels like 3/2/1.

### Log Analysis Processing According to Embodiment 1

FIG. 7 is a flowchart illustrating the log analysis processing according to according to Embodiment 1. The log analysis processing is executed by the log analysis support system 1 as triggered when the failure information, the failure occurrence location, and the analysis target period are input by the user 4 who operates the input device 105 by the log analysis support system 1.

Firstly, in step S11, the analysis method decision unit 11 acquires the failure information, the failure occurrence location information, and the analysis target period which are input by the user 4. Next, in step S12, the analysis method decision unit 11 acquires each information of the system name T31 corresponding to the failure occurrence location information, regarding which the input was received from the system configuration information T3 in step S11, and the corresponding file path T32 and connection destination T33.

Next, in step S13, the analysis method decision unit 11 refers to, for example, the rule information T2 and decides a log file(s) 22L to be acquired based on the information acquired in step S11 and step S12. The log file(s) 22L to be acquired may be decided by, for example, using generative AI (Artificial Intelligence), but not the rule information T2.

Then, in step S14, the analysis method decision unit 11 acquires the log file(s) 22L, which is decided in step S13 and relates to the analysis target period acquired in step S11, based on the file path T32 acquired in step S12.

Subsequently, in step S15, the analysis method decision unit 11 judges whether the number of the log files 22L acquired in step S13 is one or not. If the number of the log files 22L decided to be acquired in step S13 is one (YES in step S15), the analysis method decision unit 11 causes the processing to proceed to step S16; and if the number of the log files 22L acquired in step S13 is more than one (NO in step S15), the analysis method decision unit 11 causes the processing to proceed to step S18.

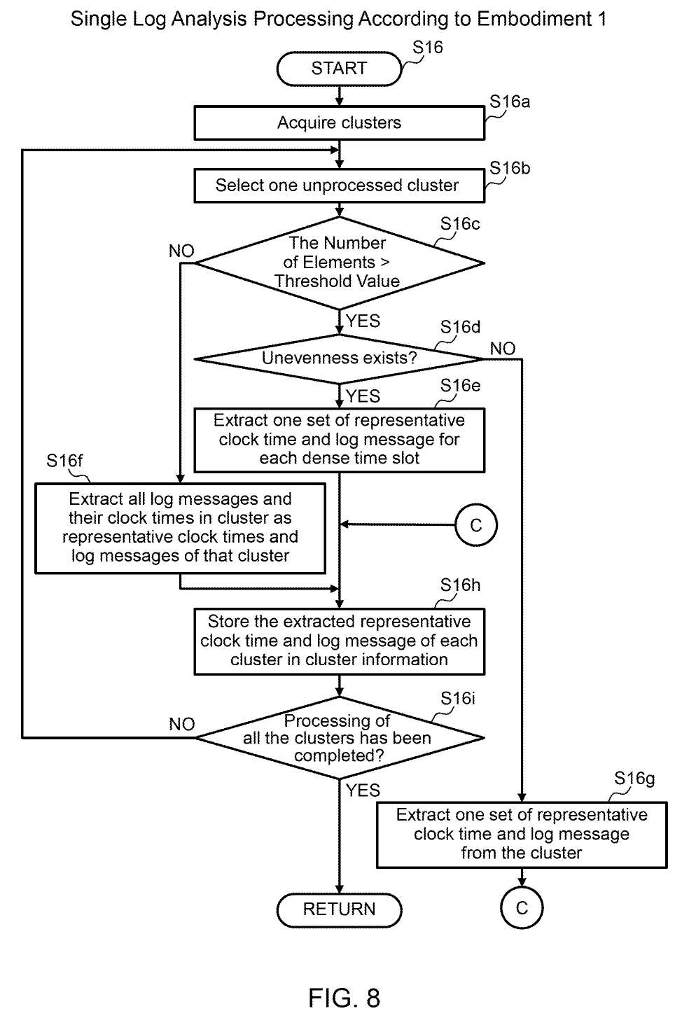

In step S16, the single log analysis unit 13a executes the single log analysis processing. The details of the single log analysis processing will be described later with reference to FIG. 8. Next, in step S17, the single log analysis unit 13a sorts all clusters stored in the cluster information T4 in a sequential order of representative clock times.

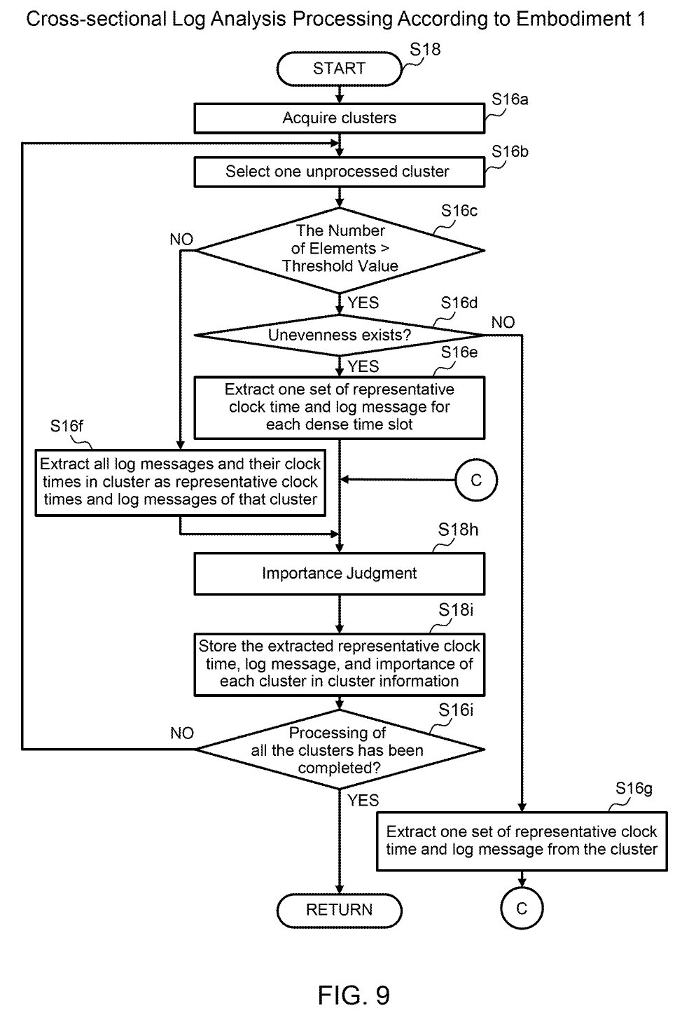

On the other hand, in step S18, the cross-sectional log analysis unit 13b executes the cross-sectional log analysis processing. The details of the cross-sectional log analysis processing will be described later with reference to FIG. 9. Next, in step S19, the cross-sectional log analysis unit 13b selects clusters based on the information of the importance T47 from among the clusters stored in the cluster information T4. In step S20, the cross-sectional log analysis unit 13b selects, for example, clusters regarding which the information of the importance T47 is equal to or greater than a certain level. Then, in step S20, the cross-sectional log analysis unit 13b sorts the clusters selected in step S19 in the sequential order of representative clock times. Next, in step S21, the cross-sectional log analysis unit 13b groups the clusters sorted in step S20 based on the representative clock time. In step S21, the cross-sectional log analysis unit 13b forms, for example, the clusters having a time correlation with (or temporally close within a specified range to) the representative clock time into the same group. The cross-sectional log analysis unit 13b assigns the same group ID to the clusters belonging to the same group and stores it in the group ID_T42 of the cluster information T4.

Steps S16 and S17 are examples of a first processing method in the processing method for generating the cluster information T4. Also, steps S18 to S21 are examples of a second processing method in the processing method for generating the cluster information T4.

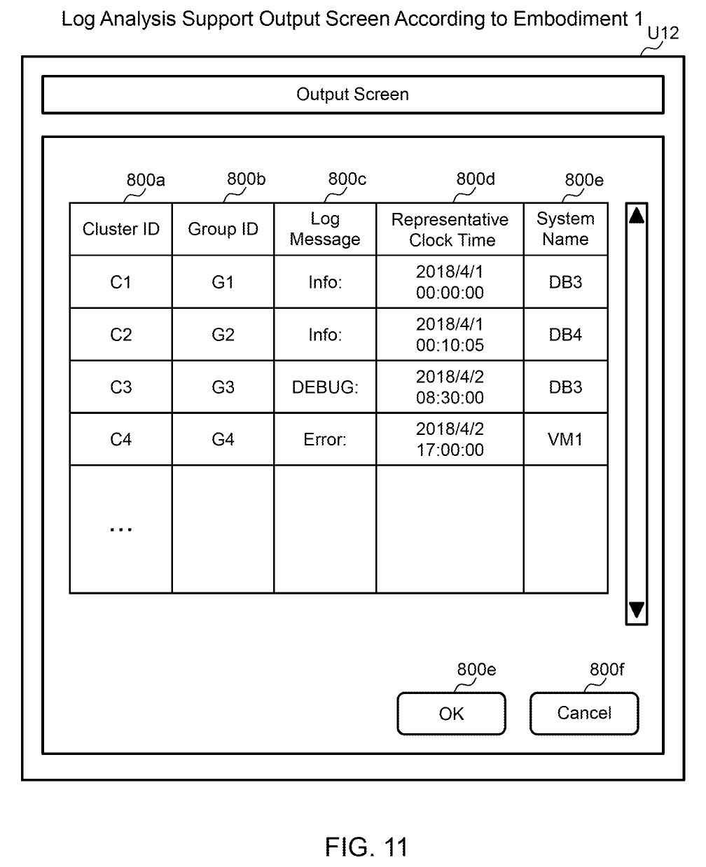

When step S17 or step S21 is finished, in step S22, the cluster analysis unit 13 outputs log analysis support information including the cluster processing results of step S17 or step S21 to a log analysis support output screen U12 (FIG. 11) described later.

### Single Log Analysis Processing According to Embodiment 1 (Step S16)

FIG. 8 is a flowchart illustrating the single log analysis processing (step S16) according to Embodiment 1. The single log analysis processing (step S16) is executed as triggered when the clustering of log entries of one log file 22L decided in step S13 is finished and clusters of the log entries are generated.

Firstly, in step S16a, the single log analysis unit 13a acquires clusters generated by the clustering processing unit 12. Next, in step S16b, the single log analysis unit 13a selects one unprocessed cluster from the clusters acquired in step S16a. Then, in step S16c, the single log analysis unit 13a judges whether the number of elements of log entries in the cluster selected in step S16b exceeds a threshold value (a specified number) or not. This threshold value may be decided by any manner, for example, the user 4 may input the threshold value in advance or the threshold value may be decided by using an upper limit token count described later. If the number of elements of the log entries in the relevant cluster exceeds the threshold value (YES in step S16c), the single log analysis unit 13a causes the processing to proceed to step S16d; and if the number of elements of the log entries in the relevant cluster does not exceed the threshold value (NO in step S16c), the single log analysis unit 13a causes the processing to proceed to step S16f.

In step S16d, the single log analysis unit 13a judges whether unevenness exists in occurrence clock times of the log entries in the relevant cluster. The judgment of whether the unevenness exists or not is performed as follows. Specifically speaking, for example, when previously designated specified time t and specified time s are used to group log entries, whose clock time difference is within t in the analysis target period, into the same group, and if all the clock time differences between the respective groups are equal to or more than s, it is determined that the unevenness exists. Specifically speaking, it is determined that the unevenness exists in the state where the difference between the latest clock time of log entries included in a certain group and the earliest clock time of log entries included in another group is always equal to or more than s. A time slot regarding which a distribution of the clock times when the unevenness exists is referred to as a first time slot, and a time slot regarding which a distribution of the clock times is dense is referred to as a second time slot. The judgment of whether the unevenness exists or not may be performed by using, for example, the generative AI. If the unevenness exists in the occurrence clock times of the log entries in the relevant cluster (YES in step S16d), the single log analysis unit 13a causes the processing to proceed to step S16e; and if the unevenness does not exist (NO in step S16d), the single log analysis unit 13a causes the processing to proceed to step S16g.

In step S16e, the single log analysis unit 13a extracts one set of the representative clock time and the log message for each dense clock time slot (each group of log entries whose clock time difference is equal to or less than t). Moreover, in step S16f, the single log analysis unit 13a extracts all the log messages in the relevant cluster and their clock times, excluding any duplicates, as the representative clock times and the log messages. Furthermore, in step S16g, the single log analysis unit 13a extracts one set of the representative clock time and the log message from the relevant cluster. In steps S16e and S16g, the single log analysis unit 13a may, for example, randomly select one set of the representative clock time and the log message in the cluster or may select a log entry of the first or last occurrence clock time, or either way is fine.

When steps S16e, S16f, S16g are finished, in step S16h, the single log analysis unit 13a stores the representative clock time and the log message of each cluster extracted in steps S16e, S16f, S16g in the cluster information T4. Next, in step S16i, the single log analysis unit 13a judges whether or not all the clusters have been selected and the processing is completed in step S16b. If all the clusters have been selected (YES in step S16i), the single log analysis unit 13a terminates the single log analysis processing (step S16); and if any unselected cluster exists (NO in step S16i), the single log analysis unit 13a causes the processing to return to step S16b.

### Cross-sectional Log Analysis Processing According to Embodiment 1 (Step S18)

FIG. 9 is a flowchart illustrating the cross-sectional log analysis processing according to Embodiment 1 (step S18). The cross-sectional log analysis processing (step S18) is executed as triggered when the clustering of the log entries of the plurality of log files 22L selected in step S13 is finished and clusters of the log entries are generated.

As compared to the single log analysis processing (step S16) (FIG. 8), the cross-sectional log analysis processing (step S18) is different because steps S18h and S18i are executed, instead of step S16h, after steps S16e, S16f, S16g. Other than this, the cross-sectional log analysis processing (step S18) is similar to the single log analysis processing (step S16). The cross-sectional log analysis processing (step S18) will be described below by focusing on the difference from the single log analysis processing (step S16).

In step S18h, the cross-sectional log analysis unit 13b judges the importance T47 of the log entries extracted in steps S16e, S16f, S16g (FIG. 9) by using a specified judgment method. The specified judgment method may be performed, for example, by inputting the log entries in the cluster to the generative AI and judging the importance T47, or by judging the importance T47 so that the importance T47 is higher when the number of the log entries or the number of dense time slots is smaller.

Next, in step S18i, the cross-sectional log analysis unit 13b stores the representative clock times, the log messages, and the importance judged in step S18h of each cluster extracted in steps S16e, S16f, S16g (FIG. 9) in the cluster information T4.

### Log Analysis Support Input Screen U11 According to Embodiment 1

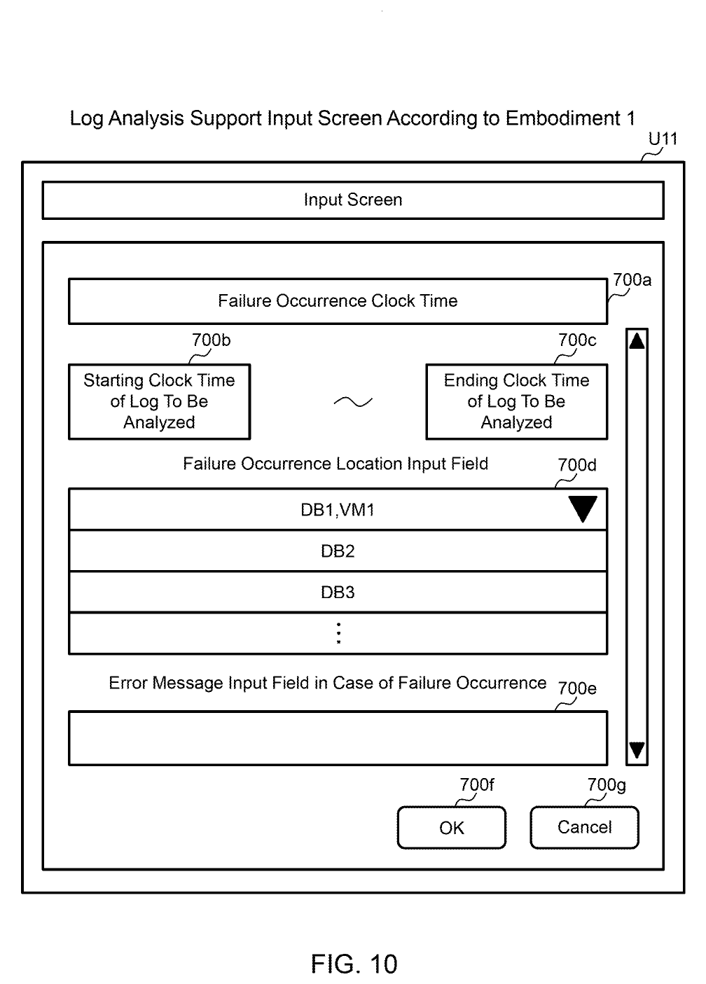

FIG. 10 is a diagram illustrating the configuration of a log analysis support input screen U11 according to Embodiment 1. The log analysis support input screen U11 is displayed on a display screen of the output device 106. The log analysis support input screen U11 has a function that enables the user 4 to input the failure occurrence clock time, the analysis target period, the failure occurrence location, and an error message upon the occurrence of a failure.

Regarding the function to input the failure occurrence clock time, the log analysis support input screen U11 has, for example, a failure occurrence clock time input field 700a in which clock time information can be input. Moreover, regarding the function to input the analysis target period, the log analysis support input screen U11 has, for example, a starting clock time input field 700b for a log to be analyzed, in which the clock time information can be input, and an ending clock time input field 700c for the log to be analyzed, in which the clock time information can be input.

Furthermore, the log analysis support input screen U11 has a failure occurrence location input field 700d, an error message input field in case of failure occurrence 700e, a decide button 700f, and a cancel button 700g. The failure occurrence location input field 700d is to select and input the location where the failure has occurred, from the system name T31 in the system configuration information T3. The error message input field in case of failure occurrence 700e is where a log message can be input when detecting the failure. The decide button 700f is to issue an instruction to cause the input to be reflected and execute the log analysis processing (FIG. 7). The cancel button 700g is to discard the input and close the screen.

### Log Analysis Support Output Screen U12 According to Embodiment 1

FIG. 11 is a diagram illustrating the configuration of a log analysis support output screen U12 according to Embodiment 1. The log analysis support output screen U12 is displayed on the display screen of the output device 106. The log analysis support output screen U12 has, as information elements to be output, a cluster ID 800a, a group ID 800b, a log message 800c, a representative clock time 800d, and a system name 800e.

The cluster ID 800a is where the cluster ID_T41 in the cluster information T4 is output. The group ID 800b is where the group ID_T42 in the cluster information T4 is output. The log message 800c is where the log message T44 in the cluster information T4 corresponding to the cluster ID which is output to the cluster ID 800a is output. The representative clock time 800d is where the representative clock time T42 in the cluster information T4 corresponding to the cluster ID which is output to the cluster ID 800a is output. The system name 800e is where the system name T31 acquired from the system configuration information T3 is output based on the file path T45 in the cluster information T4 corresponding to the cluster ID which is output to the cluster ID 800a.

### Advantageous Effects of Embodiment 1

In the aforementioned Embodiment 1, the processing method for generating the cluster information based on the clusters generated by clustering the logs based on the content of the logs stored in the analysis target log files is decided according to the number of the analysis target log files. Consequently, according to Embodiment 1, the burden on the user who performs the log analysis is reduced according to the number of the analysis target log files.

Furthermore, in the aforementioned Embodiment 1, by the first processing method in the case where the number of the analysis target log files is one, the cluster information is generated by assigning the representative clock times to the clusters based on the occurrence clock times of logs included in the clusters. Furthermore, by the second processing method in the case where the number of the analysis target log files is more than one, the representative clock times are assigned to the clusters based on the occurrence clock times of the logs, and the importance is assigned to the clusters and a cluster which becomes the basis for generating the cluster information is selected based on the importance. Specifically speaking, in Embodiment 1, the processing method for the clustered logs is changed depending on the system configuration of whether the number of the analysis target log files is one or more than one (that is, the number of constituent elements which output the log files is one or more than one), the cause of failure, and so on. Therefore, according to Embodiment 1, if the number of the logs is small, all the logs in the clusters are extracted; and if the number of the logs is large, it becomes possible to extract and compare the representative important logs in the clusters.

Furthermore, in the aforementioned Embodiment 1, if the unevenness exists in the occurrence clock times of the logs of the clusters, the representative clock time is assigned to each dense time slot of the occurrence clock time; and if the unevenness does not exist in the clusters, the representative clock time is assigned to each cluster. Specifically speaking, in Embodiment 1, concerning the logs to be analyzed regarding which the distribution of the occurrence clock times is dense, the representative clock time is assigned to them collectively; and concerning the logs regarding which the distribution of the occurrence clock times is sparse, the representative clock time is assigned to the logs, respectively. Therefore, according to Embodiment 1, it is possible to keep a balance between the burden reduction for the log analysis by screening the logs and the prevention of missed extraction of the necessary logs for the analysis.

Furthermore, in the aforementioned Embodiment 1, the importance of clusters is decided based on the number of logs included in the clusters or the number of time slots with the dense distribution of the logs. Therefore, when the number of clusters of the logs is large, the advantageous effect of screening the clusters of the logs based on the importance more appropriately can be expected by breaking down the importance into finer levels.

Furthermore, in the aforementioned Embodiment 1, when a plurality of the analysis target log files are extracted, the cluster information is generated by the second processing method by grouping the selected clusters based on the representative clock times. Therefore, when the number of the clusters of the logs is large, the clusters can be easily handled on a group basis by grouping the clusters based on the representative clock times.

### Embodiment 2

Embodiment 2 will be described by focusing on the difference from Embodiment 1. In Embodiment 1, the execution results of the log analysis processing (FIG. 7) are output to the log analysis support output screen U12 (FIG. 11). The user 4 performs the failure analysis based on the logs manually or by using the generative AI on the basis of the support information displayed on the log analysis support output screen U12. However, the failure analysis may not sometimes produce sufficiently good results by using the support information displayed on the log analysis support output screen U12. Embodiment 2 deals with the above-described situation and is designed to produce the good results of the failure analysis sufficiently by re-executing the log analysis processing and obtaining new support information.

### Log Analysis Support Input Screen U21 According to Embodiment 2

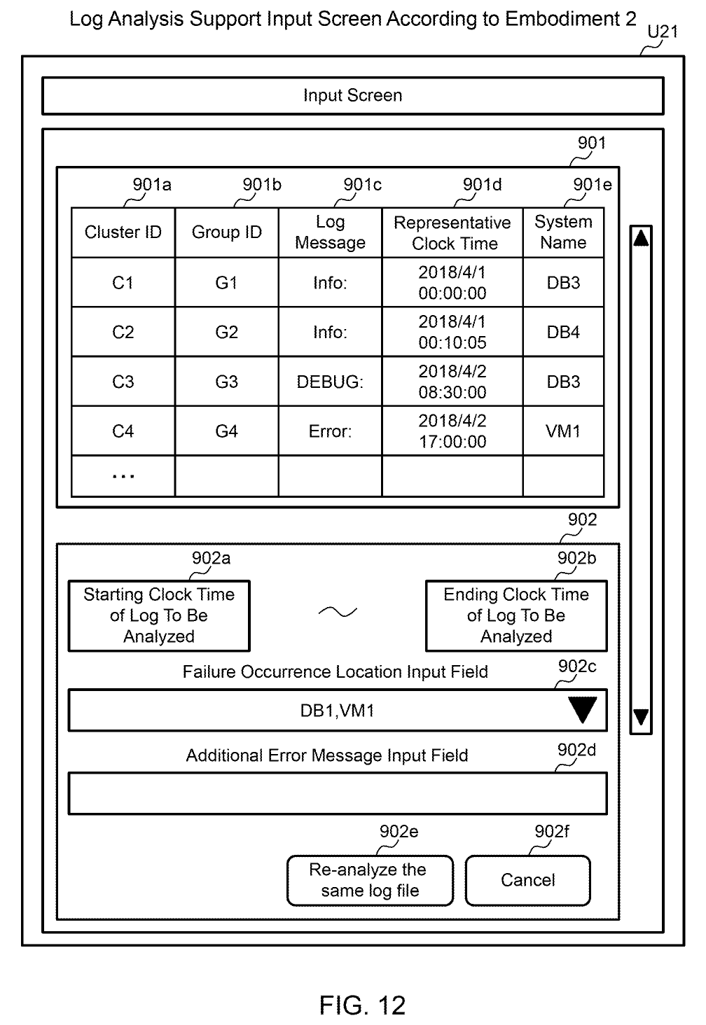

FIG. 12 is a diagram illustrating the configuration of a log analysis support input screen U21 according to Embodiment 2. The log analysis support input screen U21 has a function for the log analysis support system 1 to output the log analysis results to the user 4 and a function to input additional information upon the execution of a re-analysis function that enables the user 4 to perform the log analysis again about the details of the same failure.

The log analysis support input screen U21 has an output part 901 and an input part 902. The output part 901 has, as information elements to be output, a cluster ID 901a, a group ID 901b, a log message 901c, a representative clock time 901d, and a log output system name 901e. The information which is output from the output part 901 is the same as that of the log analysis support output screen U12 (FIG. 11).

The input part 902 has a function capable of inputting the analysis target period and the failure information and a function to issue the instruction to re-analyze the same log file. Regarding the analysis target period inputting function, the input part 902 has, for example, a starting clock time input field 902a of a log to be analyzed and an ending clock time input field 902b of the log to be analyzed.

Regarding the failure information inputting function, the input part 902 has a failure occurrence location input field 902c and an error message input field in case of failure occurrence 902d. Regarding the function to issue the instruction to re-analyze the same log file, the input part 902 has, for example, a re-analysis instruction button 902e for accepting the instruction to re-analyze the same log file 22L and a cancel button 902f. When the re-analysis instruction button 902e is pressed by the user 4, the re-analysis instruction is output. When the cancel button 902f is pressed by the user 4, the input content of the log analysis support input screen U21 is discarded and the screen is closed.

Moreover, the input part 902 may be capable of, as the input function, inputting information other than the above-mentioned information. For example, when the log analysis is executed by using the generative AI based on the output content of the output part 901, the input part 902 may be provided with, for example, a free input field for accepting texts to be input to prompts of the generative AI.

### Re-analysis Processing According to Embodiment 2

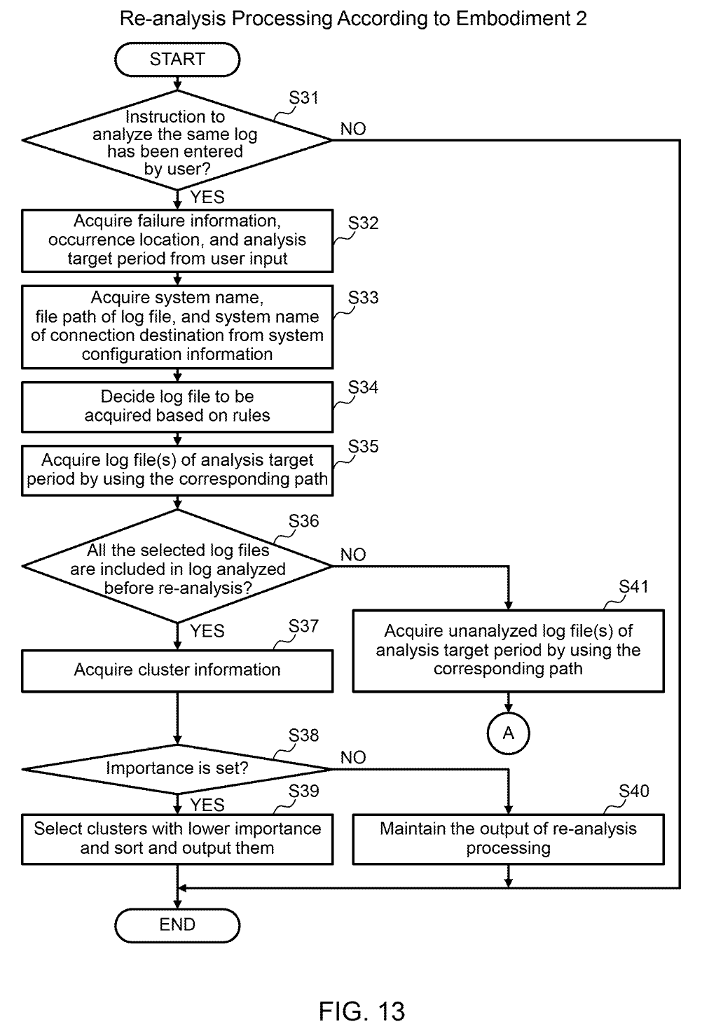

FIG. 13 is a flowchart illustrating re-analysis processing according to Embodiment 2. The re-analysis processing is executed by the cluster analysis unit 13 as triggered by the re-analysis instruction from the user 4, who pressed the re-analysis instruction button 902e, via the log analysis support system 1.

Firstly, in step S31, the cluster analysis unit 13 judges whether the re-analysis instruction to re-analyze the same log file has been entered by the user 4, for example, whether the re-analysis instruction button 902e (FIG. 12) is pressed. If the re-analysis instruction has been entered (YES in step S31), the cluster analysis unit 13 causes the processing to proceed to step S32; and if the re-analysis instruction has not been entered (NO in step S31), the cluster analysis unit 13 terminates this re-analysis processing.

In step S32, the cluster analysis unit 13 acquires the analysis target period and the details of the failure, which are input in the starting clock time input field 902a, the ending clock time input field 902b, the failure occurrence location input field 902c, and the error message input field in case of failure occurrence 902d within the input part 902. Subsequent steps S33, S34, S35 are the same as steps S12, S13, S14 (FIG. 7).

Next, in step S36, the cluster analysis unit 13 judges whether all the log files acquired in step S35 are included in the log files which were analyzed by the log analysis processing (FIG. 7) executed last time with respect to the re-analysis processing which is currently executed, or by the execution of the re-analysis processing. If all the log files are included (YES in step S36), the cluster analysis unit 13 causes the processing to proceed to step S37; and if some or all the log files are not included (NO in step S37), the cluster analysis unit 13 causes the processing to proceed to step S41.

In step S37, the cluster analysis unit 13 acquires the cluster information T4 generated by the execution of the previous log analysis processing (FIG. 7) or the re-analysis processing. Then, in step S38, the cluster analysis unit 13 judges whether the information of the importance T47 is set to the cluster information T4 acquired in step S37. If the information of the importance T47 is set to the cluster information T4 (YES in step S38), the cluster analysis unit 13 causes the processing to proceed to step S39. On the other hand, if the information of the importance T47 is not set to the cluster information T4 (NO in step S38), the cluster analysis unit 13 causes the processing to proceed to step S40.

In step S39, the cluster analysis unit 13 selects clusters with lower importance (for example, one-level lower importance) than the importance used to execute the previous log analysis processing (FIG. 7) or the re-analysis processing, from the clusters corresponding to the relevant log files. Then, the cluster analysis unit 13 sorts the selected clusters according to the representative clock times and output them to the log analysis support output screen U12 (FIG. 11). On the other hand, in step S40, the cluster analysis unit 13 does not update, but maintains the outputs of the clusters which are currently output to the log analysis support output screen U12.

Furthermore, in step S41, the cluster analysis unit 13 acquires log files which were not analyzed before the re-analysis and which are included in the analysis target period acquired in step S32, among the log files selected in step S35. When step S41 is finished, the cluster analysis unit 13 causes the processing to proceed to step S15 of the log analysis processing (FIG. 7).

### Advantageous Effect of Embodiment 2

In the aforementioned Embodiment 2, it is possible to present the information which is included in the clusters and is required for the failure analysis, without omissions, to the user upon the re-analysis processing by presenting the clusters which were judged to have the low importance and were not presented to the user in the previous log analysis processing (FIG. 7) or the re-analysis processing.

### Embodiment 3

Embodiment 3 will be described by focusing on the difference from Embodiment 1. In Embodiment 1, there are no restrictions on the execution results of the log analysis processing (for example, the log message 800b) which are output to the log analysis support output screen U12 (FIG. 11). However, when performing the failure analysis by inputting the execution results to the generative AI, this may sometimes conflict with restrictions on the generative AI’s token count, so the failure analysis cannot be performed smoothly. Embodiment 3 is designed to cause the failure analysis using the generative AI to be performed smoothly by generating the execution results of the log analysis processing in consideration of the generative AI’s token count.

### Log Analysis Support Input Screen U31 According to Embodiment 3

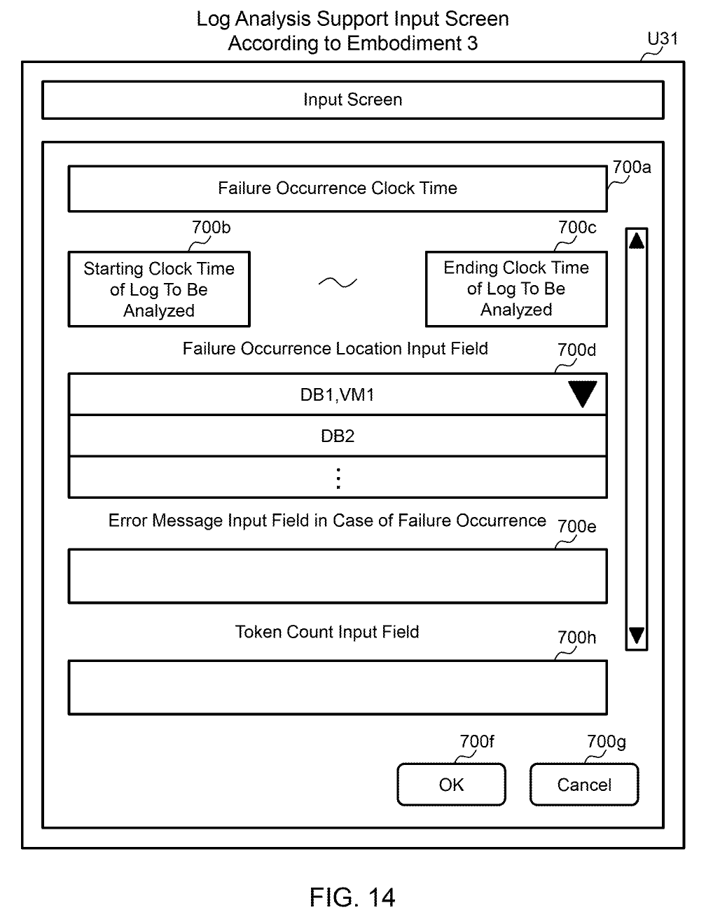

FIG. 14 is a diagram illustrating the configuration of a log analysis support input screen U31 according to Embodiment 3. The log analysis support input screen U31 has a function to set an upper limit token count according to Embodiment 3. The token count indicates a minimum unit when inputting text data to a model such as the generative AI. The upper limit token count setting function is a function that causes a total token count of the log analysis results to be output to become equal to or less than the token count designated by the user 4. As compared to the log analysis support input screen U11 of Embodiment 1, the log analysis support input screen U31 of Embodiment 3 is different because it has a token count input field 700h where the upper limit token count can be input; and other than this, the log analysis support input screen U31 is similar to the log analysis support input screen U11.

As compared to the log analysis processing (FIG. 7) of Embodiment 1, the log analysis processing of Embodiment 3 is different because step S16C is executed instead of step S16 and step S18C is executed instead of step S18; and other than this, the log analysis processing of Embodiment 3 is similar to the log analysis processing of Embodiment 1.

### Single Log Analysis Processing According to Embodiment 3 (Step S16C)

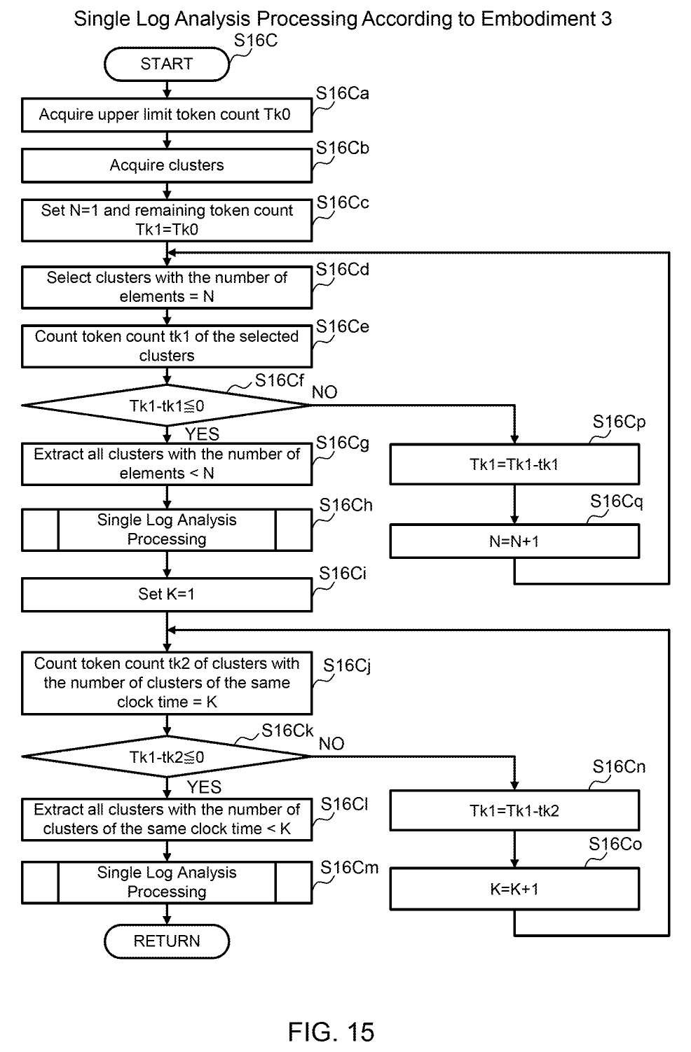

FIG. 15 is a flowchart illustrating the single log analysis processing (step S16C) according to Embodiment 3. The single log analysis processing (step S16C) is executed when the clustering of log entries of one log file 22L selected in step S13 (FIG. 7) is finished and clusters of the log entries are generated.

Firstly, in step S16Ca, the single log analysis unit 13a acquires an upper limit token count Tk0 (a specified number) which is input to the token count input field 700h in the log analysis support input screen U31. Next, in step S16Cb, the single log analysis unit 13a acquires the clusters generated by the clustering processing unit 12. Then, in step S16Cc, the single log analysis unit 13a sets “1” to a counter variable N and thereby sets the remaining token count Tk1=Tk0.

Then, in step S16Cd, the single log analysis unit 13a selects clusters regarding which the number of elements included in the clusters acquired in step S16Cb is N. Subsequently, in step S16Ce, the single log analysis unit 13a counts a token count tk1 of clock times and log messages of all the log entries included in the clusters selected in step S16Cd, excluding duplicates of the clock times and the log messages.

Next, in step S16Cf, the single log analysis unit 13a judges whether (Tk1-tk1)≤0 is satisfied or not. In the case of (Tk1-tk1)≤0 (YES in step S16Cf), the single log analysis unit 13a causes the processing to proceed to step S16Cg; and in the case of (Tk1-tk1)>0 (NO in step S16Cf), the single log analysis unit 13a causes the processing to proceed to step S16Cp.

In step S16Cg, the single log analysis unit 13a extracts clusters with the number of elements < N. Next, in step S16Ch, the single log analysis unit 13a executes the single log analysis processing (step S16) (FIG. 8) with respect to all the clusters extracted in step S16Cg. Then, in step S16Ci, the single log analysis unit 13a sets “1” to the counter variable K.

Subsequently, in step S16Cj, the single log analysis unit 13a counts a token count tk2 of clock times and log messages of clusters with the number of clusters of the same clock time = K, excluding any duplicates, among the clusters which were acquired in step S16Cb, but were not extracted in step S16g.

Next, in step S16Ck, the single log analysis unit 13a judges whether (Tk1-tk2)≤0 is satisfied or not. In the case of (Tk1-tk2)≤0 (YES in step S16Ck), the single log analysis unit 13a causes the processing to proceed to step S16Cl; and in the case of (Tk1-tk2)>0 (NO in step S16Ck), the single log analysis unit 13a causes the processing to proceed to step S16Cn.

In step S16Cl, the single log analysis unit 13a extracts clusters with the number of clusters of the same clock time < K from the clusters which were acquired in step S16Cb, but were not extracted in step S16g. Then, in step S16Cm, the single log analysis unit 13a executes the single log analysis processing (step S16) (FIG. 8) with respect to all the clusters extracted in step S16Cl.

Incidentally, if the number of the clusters extracted in step S16Cl is 0, the single log analysis unit 13a cancels the execution of step S16Cm and terminates the single log analysis processing (FIG. 15), and causes the processing to proceed to step S17 of the log analysis processing (FIG. 7).

On the other hand, in step S16Cp, the single log analysis unit 13a updates Tk1 with (Tk1-tk1). Next, in step S16Cq, the single log analysis unit 13a increments N by 1. When step S16Cq is finished, the single log analysis unit 13a causes the processing to return to step S16Cd.

Moreover, in step S16Cn, the single log analysis unit 13a updates Tk1 with (Tk1-tk2). Then, in step S16Co, the single log analysis unit 13a increments K by 1. When step S16Co is finished, the single log analysis unit 13a causes the processing to return to step S16Cj.

In step S16Cd to S16Ch, the cluster information T4 is generated base on the clusters regarding which the number of elements is much smaller; and if there is a further excessive amount in the token count, the cluster information T4 is generated based on the clusters regarding which the number of the clock times is much smaller in steps S16Cj to S16Cm. Consequently, the cluster information T4 can be generated by extracting the clusters until the token count of the clock times and the log messages becomes close to the upper limit as much as possible.

### CROSS-SECTIONAL LOG ANALYSIS PROCESSING ACCORDING TO EMBODIMENT 3 (STEP S18C)

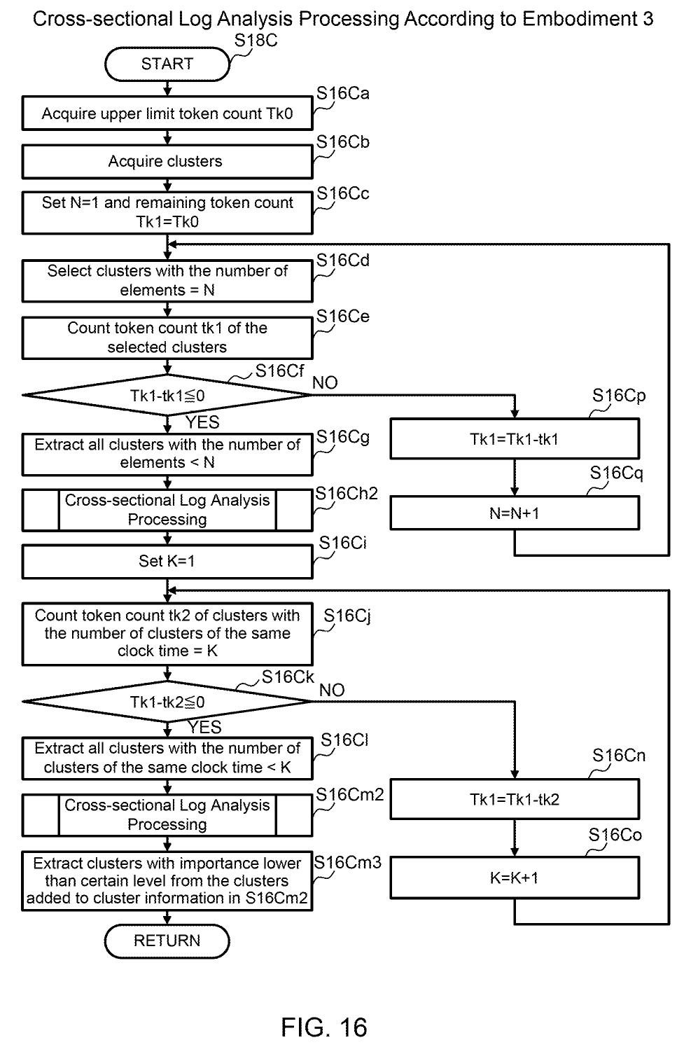

FIG. 16 is a flowchart illustrating the cross-sectional log analysis processing (step S18C) according to Embodiment 3. The cross-sectional log analysis processing (step S18C) is executed as triggered when the clustering of the log entries of the plurality of log files 22L selected in step S13 (FIG. 7) is finished and clusters of the log entries are generated.

As compared to the single log analysis processing (step S16C) (FIG. 15), the cross-sectional log analysis processing (step S18C) is different because step S16Ch2 is executed instead of step S16Ch. Moreover, it is different because step S16Cm2 and step S16Cm3 are executed instead of step S16Cm. Other than these differences, the cross-sectional log analysis processing (step S18C) is similar to the single log analysis processing (step S16C). The cross-sectional log analysis processing (step S18C) will be described below by focusing on the differences from the single log analysis processing (step S16C).

In step S16Ch2, the cross-sectional log analysis unit 13b executes the cross-sectional log analysis processing (step S18) (FIG. 9) with respect to all the clusters extracted in step S16Cg. Moreover, in step S16Cm2, the cross-sectional log analysis unit 13b executes the cross-sectional log analysis processing (step S18) (FIG. 9) with respect to all the clusters extracted in step S16Cl. Next, in step S16Cm3, the cross-sectional log analysis unit 13b excludes the clusters with the importance lower than a certain level from the clusters added to the cluster information T4 in step S16Cm2.

Incidentally, when the number of the clusters extracted in step S16Cl is 0, the cross-sectional log analysis unit 13b cancels the execution of step S16Cm2 and step S16Cm3 and terminates the single log analysis processing (FIG. 15), and causes the processing to proceed to step S19 of the log analysis processing (FIG. 7).

Incidentally, in this embodiment, count targets of the token count are the representative clock times and the log messages of the clusters; however, the count targets of the token count are not limited to the above-mentioned example and can be changed as appropriate.

### Advantageous Effects of Embodiment 3

In the aforementioned Embodiment 3, the token count of the outputs can be managed to become equal to or less than a certain number, regardless of the number of the acquired log files, the log entries, and the clusters, by the single log analysis processing and the cross-sectional log analysis processing. Consequently, for example, when it is desired to use the generative AI to analyze the clustered logs, cost and the number of inputs can be controlled. Specifically speaking, when creating inputs to the generative AI prompts, an input amount can be reduced appropriately according to the system configuration and the cause of failure.

Moreover, in the aforementioned Embodiment 3, clusters are selected based, on the importance, from the narrowed-down clusters and the cluster information is generated based on the selected clusters. Therefore, the clusters can be further screened according to the importance and the input amount to the generative AI prompts can be further reduced.

The present invention is not limited to the aforementioned embodiments and includes various variations. For example, the aforementioned embodiments have been described in detail in order to explain the invention in an easily comprehensible manner and are not necessarily limited to those having all the configurations explained above. Furthermore, part of the configuration of a certain embodiment can be replaced with the configuration of another embodiment and the configuration of another embodiment can be added to the configuration of a certain embodiment. Also, regarding part of the configuration of each embodiment, addition, deletion, or replacement of the configuration of another configuration can be performed. Furthermore, part or all of the aforementioned configurations, functions, processing units, processing means, and so on may be realized by hardware by, for example, designing them in integrated circuits. Also, each of the aforementioned configurations, functions, and so on may be realized by software by processors interpreting and executing programs for realizing each of the functions.

1. A log analysis support method executed by a log analysis support system for supporting analysis of logs which are output when an incident occurs at a target system,
wherein the log analysis support system has a processor and a memory;
wherein the memory stores:
system configuration information having storage location information indicating storage locations of log files in which the logs relating to constituent elements that configures the target system are stored; and
rule information indicating the constituent element, which are targets to acquire the logs, with respect to failure information indicating details of the incident or failure occurrence location information indicating the constituent element where the incident has occurred; and
wherein the processor has respective processes for:
accepting the failure information, the failure occurrence location information, and an analysis target period which are input by a user;
identifying the storage location information of the log files, which are analysis targets, based on the failure information or the failure occurrence location information as well as the system configuration information and the rule information;
acquiring the analysis target log files which correspond to the analysis target period, from the target system by using the identified storage location information;
deciding, according to a quantity of the analysis target log files, a processing method for generating cluster information based on a cluster or clusters generated by clustering the logs based on content of the logs stored in the acquired analysis target log files;
generating the cluster information by using the decided processing method; and
outputting support information for supporting the analysis of the logs based on the generated cluster information.

2. The log analysis support method according to claim 1,
wherein regarding the processing method, there are a first processing method when the quantity of the analysis target log files is one, and a second processing method when the quantity of the analysis target log files is more than one; and
wherein in the first processing method,
the processor generates the cluster information by assigning a representative clock time to the cluster based on occurrence clock times of the logs included in the cluster; and
in the second processing method, the processor:
assigns the representative clock time to the cluster based on the occurrence clock times of the logs included in the cluster;
assigns importance to the cluster by using a specified judgment method;
selects the clusters based on the importance; and
generates the cluster information based on the selected clusters.

3. The log analysis support method according to claim 2,
wherein regarding each cluster of which the quantity of the logs included in the cluster exceeds a specified number, the processor:
judges whether there exists unevenness with a first time slot or slots in which a distribution of the occurrence clock times of the logs is sparse, and a second time slot or slots in which the distribution is dense;
assigns the representative clock time to each second time slot of the cluster if the unevenness exists in the cluster; and
assigns the representative clock time to each cluster if the unevenness does not exist in the cluster.

4. The log analysis support method according to claim 3,
wherein the importance is decided based on the quantity of the logs included in the cluster or a quantity of the second time slots.

5. The log analysis support method according to claim 4,
wherein the importance is classified into a larger number of graded levels when the quantity of the analysis target log files is larger.

6. The log analysis support method according to claim 2,
wherein in the second processing method, the processor generates the cluster information by grouping the selected clusters based on the representative clock time.

7. The log analysis support method according to claim 2,
wherein the processor:
narrows down the clusters so that a token count of log messages indicating the content of the logs included in the clusters becomes equal to or less than a specified number; and
generates the cluster information based on the clusters which have been narrowed down.

8. The log analysis support method according to claim 7,
wherein the processor:
selects the cluster based on the importance from the clusters which have been narrowed down; and
generates the cluster information based on the selected cluster.

9. The log analysis support method according to claim 2,
wherein when re-executing the second processing method,
the processor selects the cluster based on the importance which is lower than the importance when the second processing method was executed last time.

10. A log analysis support system for supporting analysis of logs which are output when an incident occurs at a target system,
wherein the log analysis support system has a processor and a memory;
wherein the memory stores:
system configuration information having storage location information indicating storage locations of log files in which the logs relating to constituent elements that configure the target system are stored; and
rule information indicating the constituent elements, which are targets to acquire the logs, with respect to failure information indicating details of the incident or failure occurrence location information indicating the constituent element where the incident has occurred; and
wherein the processor:
accepts the failure information, the failure occurrence location information, and an analysis target period which are input by a user;
identifies the storage location information of the log files, which are analysis targets, based on the failure information or the failure occurrence location information as well as the system configuration information and the rule information;
acquires the analysis target log files which correspond to the analysis target period, from the target system by using the identified storage location information;
decides, according to a quantity of the analysis target log files, a processing method for generating cluster information based on a cluster or clusters generated by clustering the logs based on content of the logs stored in the acquired analysis target log files;
generates the cluster information by using the decided processing method; and
outputs support information for supporting the analysis of the logs based on the generated cluster information.

11. A log analysis support program for causing a computer having a processor and a memory to execute respective processes for:
storing system configuration information having storage location information indicating storage locations of log files in which the logs relating to constituent elements that configure the target system are stored, and rule information indicating the constituent elements, which are targets to acquire the logs, with respect to failure information indicating details of the incident or failure occurrence location information indicating the constituent element where the incident has occurred;
accepting the failure information, the failure occurrence location information, and an analysis target period which are input by a user;
identifying the storage location information of the log files, which are analysis targets, based on the failure information or the failure occurrence location information as well as the system configuration information and the rule information;
acquiring the analysis target log files which correspond to the analysis target period, from the target system by using the identified storage location information;
deciding, according to a quantity of the analysis target log files, a processing method for generating cluster information based on a cluster or clusters generated by clustering the logs based on content of the logs stored in the acquired analysis target log files;
generating the cluster information by using the decided processing method; and
outputting support information for supporting the analysis of the logs based on the generated cluster information.
